(19) United States
(12) Patent Application Publication
(10) Pub. No.: US 2023/0353651 A1
(43) Pub. Date: Nov. 2, 2023

(54) IDENTIFYING SUGGESTED CONTACTS FOR CONNECTION

(71) Applicant: Salesforce, Inc., San Francisco, CA (US)

(72) Inventors: Aaron Maurer, McLean, VA (US); Xander Johnson, San Francisco, CA (US); Lichen Ni, Vancouver (CA); Kyle Jablon, New York, NY (US)

(21) Appl. No.: 17/733,439

(22) Filed: Apr. 29, 2022

(51) Int. Cl. H04L 67/54; H04L 67/1396; H04L 67/306

(52) U.S. Cl. CPC H04L 67/54; H04L 67/1396; H04L 67/306; G06Q 50/01

(57) ABSTRACT

Systems, methods, and computer-readable media are provided for adding connections for a user. External graphs may be analyzed to identify connections and relationships which may be missing in a group-based communication system. These missing connections may be suggested to the user as a suggested virtual space. A user may then create the virtual space based on the suggestions.

### TECHNICAL FIELD

Embodiments of the invention generally relate to identifying suggested contacts to determine suggested connections. More specifically, embodiments of the invention relate to analyzing external connection data to suggest existing relationships for connection in a group-based communication system.

A wide variety of interpersonal relationships may be observed in the universe of communications between individuals, via direct communication, shared group meetings, social networks, and other digital sources. However, these relationships are often siloed in different data sets. Users who are connected via one such type of communication may wish to also connect via other platforms, but it may be hard to locate such users to collaborate with and to build up the collaboration infrastructure necessary to do so. Accordingly, what is needed is a better way to automatically identify existing relationships to suggest new connections in a group-based communication system, thereby allowing for improved collaboration.

### SUMMARY

Embodiments of the invention address the above-identified need by providing systems, methods, and media for identifying existing relationships to suggest new connections within a group-based communication system. Interpersonal relationships may be thought of as graphs, where the individuals are nodes and the relationships are edges. By analyzing relationship graph data from a variety of systems and combining multiple such graphs, existing relationships can be suggested to a user of the group-based communication system such that the user can easily recreate those existing relationships within the group-based communication system. In particular, machine learning techniques can be applied to identify corresponding nodes in relationship graphs from different sources. New connections mirroring existing relationships may be established via a message the user can send or as a new shared channel the user can create. The data from the external system may further inform how the message or channel should be presented to the user, including both the timing and content related to such a suggestion. Similarly, analyzing relationship graph data may further determine there are existing channels which a user should consider joining and suggest those existing channels to the user. Machine learning models may also be trained to improve suggestions and to discover relationships which may be obscured by incomplete data, such as by determining matching nodes based on incomplete data or based purely on similar edges.

In some aspects, the techniques described herein relate to a method for adding connections for a user, the method including: receiving, from a first external source of relationship data, a first external data set representing relationships among a first plurality of users; receiving, from a second external source of relationship data, a second external data set representing relationships among a second plurality of users; receiving an internal data set representing relationships among a plurality of internal users; wherein the first plurality of users, the second plurality of users, and the plurality of internal users represent distinct overlapping sets of users; generating a combined data set representing relationships between the first plurality of users, the second plurality of users, and the plurality of internal users; and in response to determining that the combined data set contains one or more relationships not included in the internal data set between the user and one or more unconnected users: presenting, to the user, a suggested virtual space including the user and the one or more unconnected users; receiving, from the user, an action to engage with the suggested virtual space; and in response to detecting the action, creating the suggested virtual space.

In some aspects, the techniques described herein relate to a method, further including inviting the one or more unconnected users to the suggested virtual space.

In some aspects, the techniques described herein relate to a method, further including adding the one or more unconnected users as collaborators to a collaborative document within the suggested virtual space.

In some aspects, the techniques described herein relate to a method, further including establishing a synchronous multimedia collaboration session corresponding to the user and the one or more unconnected users and the suggested virtual space.

In some aspects, the techniques described herein relate to a method, further including launching the suggested virtual space within a user interface associated with a group-based communication system.

In some aspects, the techniques described herein relate to a method, further including providing a suggested message from the user to the one or more unconnected users in the suggested virtual space.

In some aspects, the techniques described herein relate to a method, further including saving the combined data set within a group-based communication system as a new internal data set.

In some aspects, the techniques described herein relate to one or more non-transitory computer-readable media storing computer-executable instructions that, when executed by at least one processor, perform a method for adding connections for a user, the method including: receiving, from a first external source of relationship data, a first external data set representing relationships among a first plurality of users; receiving, from a second external source of relationship data, a second external data set representing relationships among a second plurality of users; receiving an internal data set representing relationships among a plurality of internal users; wherein the first plurality of users, the second plurality of users, and the plurality of internal users represent distinct overlapping sets of users; generating a combined data set representing relationships between the first plurality of users, the second plurality of users, and the plurality of internal users; and in response to determining that the combined data set contains one or more relationships not included in the internal data set between the user and one or more unconnected users: presenting, to the user, a suggested virtual space including the user and the one or more unconnected users; receiving, from the user, an action to engage with the suggested virtual space; and in response to detecting the action, creating the suggested virtual space.

In some aspects, the techniques described herein relate to a non-transitory computer-readable media, further including inviting the one or more unconnected users to the suggested virtual space.

In some aspects, the techniques described herein relate to a non-transitory computer-readable media, further including adding the one or more unconnected users as collaborators to a collaborative

In some aspects, the techniques described herein relate to a non-transitory computer-readable media, further including establishing a synchronous multimedia collaboration session corresponding to the user and the one or more unconnected users and the suggested virtual space.

In some aspects, the techniques described herein relate to a non-transitory computer-readable media, further including launching the suggested virtual space within a user interface associated with a group-based communication system.

In some aspects, the techniques described herein relate to a non-transitory computer-readable media, further including providing a suggested message from the user to the one or more unconnected users in the suggested virtual space.

In some aspects, the techniques described herein relate to a non-transitory computer-readable media, further including saving the combined data set within a group-based communication system as a new internal data set.

In some aspects, the techniques described herein relate to a system for adding connections for a user, the system including: a data store associated with a group-based communication system; and at least one processor programmed to perform a method for adding connections for the user, the method including: receiving, from a first external source of relationship data, a first external data set representing relationships among a first plurality of users; receiving, from a second external source of relationship data, a second external data set representing relationships among a second plurality of users; receiving an internal data set representing relationships among a plurality of internal users; wherein the first plurality of users, the second plurality of users, and the plurality of internal users represent distinct overlapping sets of users; generating a combined data set representing relationships between the first plurality of users, the second plurality of users, and the plurality of internal users; and in response to determining that the combined data set contains one or more relationships not included in the internal data set between the user and one or more unconnected users: presenting, to the user, a suggested virtual space including the user and the one or more unconnected users; receiving, from the user, an action to engage with the suggested virtual space; and in response to detecting the action, creating the suggested virtual space.

In some aspects, the techniques described herein relate to a system, further including inviting the one or more unconnected users to the suggested virtual space.

In some aspects, the techniques described herein relate to a system, further including adding the one or more unconnected users as collaborators to a collaborative document within the suggested virtual space.

In some aspects, the techniques described herein relate to a system, further including establishing a synchronous multimedia collaboration session corresponding to the user and the one or more unconnected users and the suggested virtual space.

In some aspects, the techniques described herein relate to a system, further including launching the suggested virtual space within a user interface associated with a group-based communication system.

In some aspects, the techniques described herein relate to a system, further including providing a suggested message from the user to the one or more unconnected users in the suggested virtual space.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1A depicts an exemplary hardware platform relating to certain embodiments of the invention;

FIG. 1B depicts a system including elements for carrying out certain embodiments of the invention;

FIG. 2A illustrates a user interface for the group-based communication system for certain embodiments;

FIG. 2B depicts an exemplary embodiment of a user interface for the group-based communication system for displaying a collaborative document;

FIG. 3A depicts a graph representing connections between individuals;

FIG. 3B depicts a graph representing connections between users in a group-based communication system.

FIG. 3C depicts a graph representing connections between users in a social media platform;

FIG. 3D depicts a graph representing connections between users in a meeting;

FIG. 4A illustrates a user interface for suggesting new channels to a user;

FIG. 4B illustrates a user interface for creating a new channel;

FIG. 4C illustrates a user interface for adding users to a new channel;

FIG. 4D illustrates a user interface for suggesting existing channels to a user;

FIG. 5 depicts a flowchart for suggesting connections to a user; and

FIG. 6 depicts a flowchart for an exemplary method for combining graphs.

The drawing figures do not limit the invention to the specific embodiments disclosed and described herein. The drawings are not necessarily to scale, emphasis instead being placed upon clearly illustrating the principles of the invention.

### DETAILED DESCRIPTION

In embodiments, users within a group-based communication system may wish to improve collaboration within the group-based communication system. To further that goal, users may wish to make the group-based communication system more closely resemble the user's existing real-world relationships. This first involves modeling the real-world relationships to determine which connections and users are currently missing from the group-based communication system and should be recreated. Second, those relationships must be analyzed to determine the optimal way those relationships should be recreated within the group-based communication system such that collaboration can be most effective and efficient. Finally, the relationships must be suggested to and accepted by the user such that they can exist within the group-based communication system and collaboration may occur.

In embodiments, modeling the real-world relationships involves analyzing graphs which resemble the real-world relationships as they exist on various external digital platforms and systems. These external digital platforms and systems can model relationships between users as graphs, with each graph having some unique aspects of the connections between users. In the graphs, the users may be represented as nodes and the relationships or connections between the users may be represented as edges. Different platforms and systems may focus on different types of connections or user data. For example, a social media platform may have a connection graph focused on sharing content between users such as pictures, videos, or status updates, and contain relationship information on the social interactions between users. In contrast, a communication graph may contain work emails between users in a business and include user information such as company, role, organization, working group, and certifications, with the relationship data focusing on working relationships centered around business. These external graphs may then be combined such that the nodes corresponding to the same users across platforms can be combined, thereby revealing connections which may otherwise not have been known.

In embodiments, these newly revealed connections may be recreated within the group-based communication system. These newly revealed connections may be between two or more users and indicate some relationship or connection which was not previously captured in the group-based communication system. In embodiments, the group-based communication system may wish to recreate these connections as channels or messages between the users. In determining how best to replicate these connections, the group-based communication system may consider specifics related to the nodes, the edges, or the graphs themselves to determine how best to recreate these relationships. In some embodiments, these relationships may already be partially represented. For example, a new connection may indicate that a user should be added to an existing channel and suggest that a user join the existing channel.

In embodiments, once the group-based communication system determines how the type of relationship should be modeled, it may then offer a suggestion to the user. These suggestions may involve the user creating a new channel, joining an existing channel, or sending a message to one or more other users. Because the goal is for the user to accept the suggestion, the suggestion may be offered at a time when the user is most likely to accept the suggestion. For example, a suggestion may be made to the user to create a channel which corresponds to a weekly meeting around the time the weekly meeting occurs, when it may be top of mind to the user. Suggestions may include additional information to more effectively recreate the relationship, such as generating a name or description for a newly suggested channel or pre-populating information in the channel or a message. In some embodiments, additional context relating to why the suggestion was made may be offered to the user. For example, a user may be told that a new channel was suggested because of a specific weekly meeting occurring on the user's calendar. If the user accepts the suggestion, a channel may be created or a message may be sent, and the appropriate other users may be notified.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

### Context and Concepts of the Invention

As used herein, the term “group-based communication system” refers to a collaborative communication system used within an organization and is distinct from a conventional email system. In some embodiments, the group-based communication system is a channel-based platform. Within the group-based communication system, communication may be organized into “channels,” each dedicated to a particular topic or set of users. Channels are generally long-lasting, persistent discussions of a particular topic. Members of a particular channel can post messages within that channel that are visible to other members of that channel together with other messages in that channel. Users may select a channel for viewing to see only those messages relevant to the topic of that channel without seeing messages posted in other channels on different topics. For example, a software development company may have different channels for each software product being developed, where developers working on each project can converse without bothering (or being bothered by) developers working on other projects. Because the channels are generally persistent and directed to a particular topic or group, users can quickly and easily refer to previous communications for reference.

In some embodiments, the group-based communication system may include synchronous multimedia collaboration sessions. Synchronous multimedia collaboration sessions may provide ambient, ad hoc multimedia collaboration in the group-based communication system. Users of the group-based communication system can quickly and easily join and leave these synchronous multimedia collaboration sessions at any time, without disrupting the synchronous multimedia collaboration session for other users. In some embodiments, synchronous multimedia collaboration sessions may be based around a particular topic, a particular channel, or a set of users, while in other embodiments, synchronous multimedia collaboration sessions may exist without being tied to any particular channel, topic, or set of users. Synchronous multimedia collaboration sessions may be short, ephemeral sessions from which no data is persisted. Alternatively, in some embodiments, synchronous multimedia collaboration sessions may be recorded, transcribed, and/or summarized for later review. Members of a particular synchronous multimedia collaboration session can post messages within a messaging thread associated with that synchronous multimedia collaboration session that are visible to other members of that synchronous multimedia collaboration session together with other messages in that thread. The “multimedia” in a synchronous multimedia collaboration session may include any or all of audio, video, screen sharing, collaborative document editing, whiteboarding, co-programming or any other form of media. A synchronous multimedia collaboration session may be started for a particular channel or direct message conversation by one or more members of that channel or direct message conversation. For example, a user may start a synchronous multimedia collaboration session in a channel as a means of communicating with other members of that channel who are presently online. The user may have an urgent decision and want immediate verbal feedback from other members of the channel. Starting a synchronous multimedia collaboration session allows the user to start an immediate audio conversation with other members of the channel without requiring scheduling.

Communication data within a group-based communication system may include messages, queries, files (e.g., documents, spreadsheets, computer code, images, video, audio, and/or electronic contact information), mentions, users or user profiles, interactions (e.g., reactions, edits, deletions, and/or prioritizations such as by pinning or starring), tickets, channels, applications integrated into one or more channels, conversations (e.g., groups of messages that have been segmented as single units), workspaces (e.g., sets of channels, users, projects, tasks within an organization that may have their own sets of permissions and that may be organized substantially in line with an organization chart in some instances) or other data generated by or shared between users of the group-based communication system that are associated with an organization's communication data using the group-based communication system.

In some instances, the communication data may comprise data associated with a user (e.g., a user profile), including, but not limited to, a user identifier, one or more communication channel identifiers associated with communication channels to which the user has been granted access, one or more group identifiers for groups (or organizations, teams, entities, or the like) with which the user is associated, an indication of whether the user is an owner or manager of any communication channels, an indication of whether the user has any communication channel restrictions, a plurality of messages, a plurality of emoji, a plurality of conversations, a plurality of conversation topics, an avatar, an email address, a real name (e.g., Austin Author), a username (e.g., austin_a), a password, user preferences and/or settings, a time zone, a status, a token, and other user-specific information. In some embodiments, the group-based communication system may additionally or alternatively store permissions data associated with permissions of individual users of the group-based communication system. In some embodiments, permissions associated with an individual user can be mapped to, or otherwise associated with, an account or profile associated with user data. Permissions can indicate which users can communicate directly with other users, which channels a user is permitted to access, restrictions on individual channels, which workspaces the user is permitted to access, and restrictions on individual workspaces, for example. In some embodiments, the permissions can support the group-based communication system by maintaining security for limiting access to a defined group of users. In some such embodiments, such users can be defined by common access credentials, group identifiers, or other criteria, as described above.

In some embodiments, the group-based communication system can be partitioned into different workspaces, which can be associated with different groups of users. Each workspace can be associated with a group identifier and one or more user identifiers can be mapped to, or otherwise associated with, the group identifier. Users corresponding to such user identifiers may be referred to as “members” of the group. A workspace may comprise one or more channels that are unique to that workspace and/or one or more channels that are shared between one or more workspaces. In some embodiments, workspaces can be associated with one or more organization identifiers, which can be associated with organizations or other entities associated with the group-based communication system. In some embodiments, such data can be mapped to, or otherwise associated with, other types of data (e.g., user data, permission data, or channel data).

The subject matter of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

### Operational Environment for Embodiments of The Invention

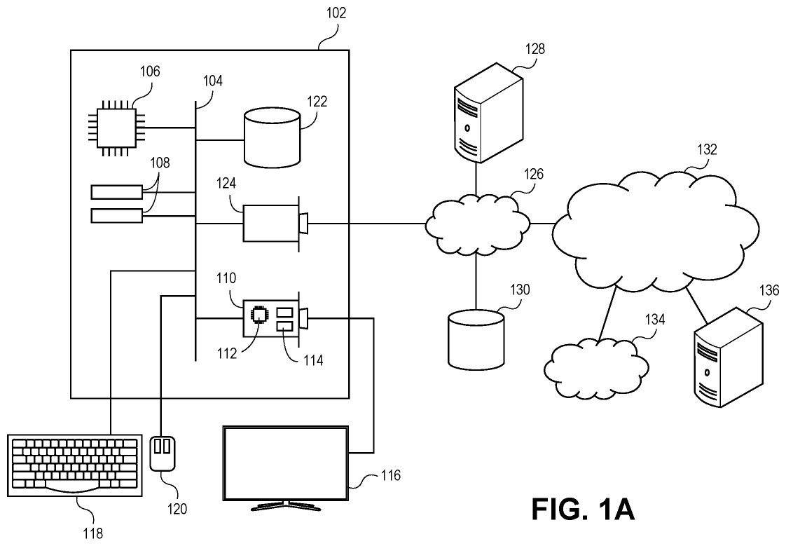

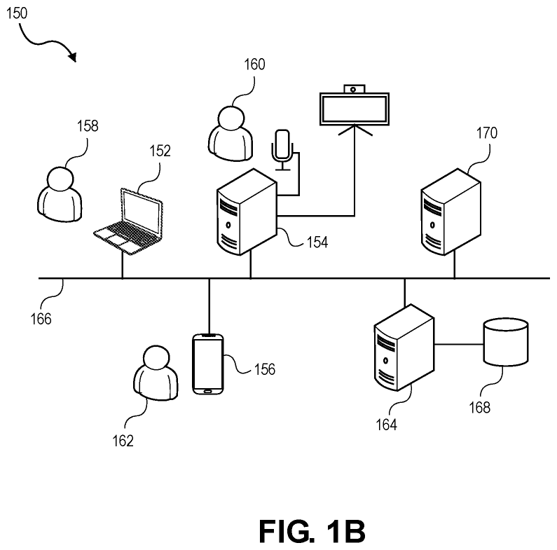

FIG. 1A illustrates an exemplary hardware platform for certain embodiments of the invention. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple buses, or components may communicate with each other directly. CPU 106 is a central processing unit (also called a processor) connected to system bus 104. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments, no display is present, while in others it is integrated into computer 102. Similarly, peripherals such as keyboard 118 and mouse 120 are connected to system bus 104. Like display 116, these peripherals may be integrated into computer 102 or absent. In some embodiments, additional peripherals such as a microphone or video camera may also be present and connected to system bus 104. In some embodiments, such peripherals may be detachable connected to computer 102 via a wired or wireless connection. In other embodiments, such as a tablet or smartphone, these peripherals are integrated into computer 102. Also connected to system bus 104 is local storage 122, which may be any form of computer-readable media, and may be internally installed in computer 102 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently and do so in a non-transitory fashion. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions for performing computer-implemented methods, data structures, program modules, and other data representations.

Finally, network interface card (NIC) 124 is also attached to system bus 104 and allows computer 102 to communicate over a network such as local network 126. NIC 124 can be any form of network interface known in the art, such as Ethernet, ATM, fiber, BLUETOOTH, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functionality for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

FIG. 1B illustrates elements of a system 150 for carrying out embodiments of the invention. System 150 includes any number of client devices such as client device 152, client device 154, and client device 156 associated with user 158, user 160, and user 162 respectively. Although system 150 is depicted with one client device per user, an individual user may connect to the group-based communication system using multiple client devices, either concurrently or sequentially. Similarly, in some embodiments, multiple users may share (concurrently or sequentially) a single client device to access the group-based communication system. As depicted in FIG. 1B, client devices may be any form of computing device discussed above with respect to FIG. 1A. In particular, a user may access the group-based communication system using a desktop, a laptop, or a mobile device. The group-based communication system may be accessible via dedicated software of the client device or via the web browser of the client device. In some embodiments, channel administrators can access administrative functionality via any client device. In other embodiments, administrative functions can only be accessed from a limited subset of client devices (for example, only via client device 152). In some embodiments, the group-based communication system is a channel-based messaging platform.

The group-based communication system is hosted by group-based communication system server 164. Group-based communication system server 164 may be a dedicated server, a shared server, a virtual machine instance in a cloud computing environment, or any other form of computing device discussed above with respect to FIG. 1A. Although only group-based communication system server 164 is depicted as a single server, embodiments with multiple such group-based communication system servers are also contemplated so as to provide scale, redundancy and/or isolation between different instances of the group-based communication system. For example, a software development company may not wish to have its group-based communications system hosted on the same server as a competitor's group-based communication system for security reasons. Group-based communication system server 164 is communicatively coupled to client devices 152, 154, and 156 via network 166. Network 166 may be a local area network (LAN), wide-area network (WAN), virtual private network (VPN) or the Internet. Broadly speaking, any type of network for providing communication between the various components of system 150 is contemplated. Group-based communication system server 164 may provide web server functionality to enable web-based clients and non-web server functionality to enable clients using a dedicated app. Alternatively, both web-based clients and dedicated-app clients might both use a single web server, or the web server might be a gateway providing web-based access to the dedicated-app server. Other techniques for enabling communication among various types of client application are also contemplated.

Group-based communication system data store 168 is communicatively connected to group-based communication system server 164. As depicted, group-based communication system data store 168 is directly connected to group-based communication system server 164; however, any form of communicative connection (for example, network-attached storage (NAS), a network file system (NFS), or cloud-based storage) can be employed. Broadly speaking, group-based communication system data store 168 stores all of the durable information used by group-based communication system server 164. For example, group-based communication system data store 168 may store all of the messages with their associated channels, documents and images uploaded to particular channels, channel membership information, and/or user information. In some embodiments, collaboration sessions may be archived and stored on the group-based communication system data store 168 for subsequent retrieval. As previously discussed, multiple group-based communication system servers may be present in system 150. In such embodiments, each group-based communication system server may have its own copy of group-based communication system data store 168. Alternatively, multiple group-based communication system servers may share a single network-attached group-based communication system data store. Alternatively, or in addition, in any of these embodiments, data may be sharded across multiple group-based communication system data stores.

Real-time media server 170 is also communicatively coupled to group-based communication system server 164 and client devices 152, 154 and 156. Real-time media server manages the multimedia aspects of real-time multimedia collaboration sessions among users of the group-based communication system as described in additional detail below. The term “multimedia” is used in this specification for brevity; however, it should be understood that the term used herein contemplates audio-only streams, video-only streams, audio/video streams, or any other combination of one or more media streams.

As depicted, the communication between real-time media server 170 is via network 166. In some embodiments, however, the real-time nature of collaboration sessions may be better served by connecting via a different network for part or all of the communicative coupling. For example, a particular client device may normally connect to group-based communication system server 164 via a cellular data connection but switch to a Wi-Fi connection when a multimedia collaboration session begins to accommodate an additional demand for bandwidth. In some embodiments, client devices may communicate multimedia collaboration data with each other via real-time media server 170 using a hub-and-spoke configuration. In other embodiments, client devices may communicate with each other directly using a peer-to-peer or supernode architecture. In still other embodiments, client devices on the same network may communicate with each other using multicast network protocols such as IP multicast. In yet other embodiments, media communication between the client devices may be via an edge-based scaling content distribution network.

### User Interface

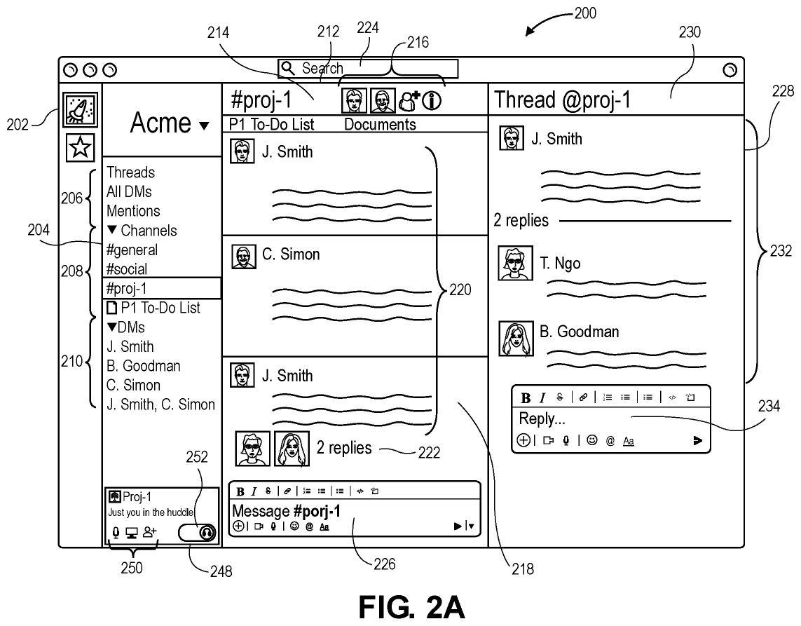

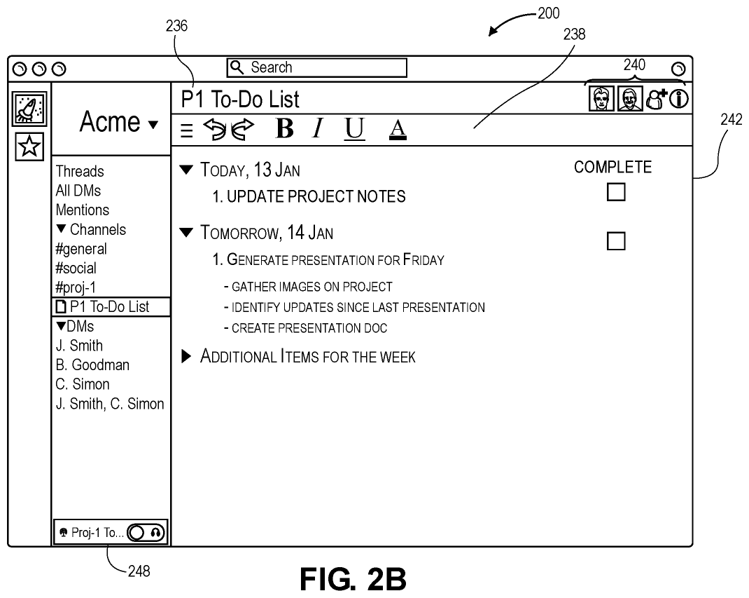

FIG. 2A illustrates a user interface 200 of a group-based communication system, which will be useful in illustrating the operation of various embodiments, as discussed in further detail below. Broadly, user interface 200 comprises a plurality of objects such as panes, text entry fields, buttons, messages, or other user interface components. As depicted, user interface 200 comprises workspace pane 202; channel list pane 204, which comprises quick info list 206, channel and document list 208, and direct message list 210; channel pane 212, which comprises channel header 214, channel controls 216, channel display 218, messages 220, and thread reply preview 222; search pane 224; compose pane 226; and thread pane 228.

As depicted, user interface 200 includes workspace pane 202 for navigating between various workspaces in the group-based communication system. In some embodiments, the group-based communication system can be portioned into different workspaces, which can be associated with different groups of users. Each workspace can be associated with a group identifier and one or more user identifiers can be mapped to, or otherwise associated with, the group identifier. Users corresponding to such user identifiers may be referred to as “members” of the group. For example, a user may be a part of a workspace for a job at Acme Software Engineering. The user may also be a member of a local volunteer organization that also uses the group-based communication system to collaborate. To navigate between the two groups, the user may use workspace pane 202 to change from the Acme workspace to the volunteer organization workspace. A workspace may comprise one or more channels that are unique to that workspace and/or one or more channels that are shared between one or more workspaces. For example, the Acme company may have a workspace for Acme Software Engineering projects, a workspace for Human Resources, and an additional workspace for general company matters. In some embodiments, workspaces can be associated with one or more organizations or other entities associated with the group-based communication system.

Users may navigate between channels using channel list pane 204. Channel list pane 204 may comprise quick info list 206 comprising various links for a user to quickly access portions of the group-based communication system. For example, as depicted, quick info list 206 comprises threads, Direct Messages (DMs), and mentions/reactions. Each of the items in quick info list 206 may be bolded, italicized, highlighted, boxed, animated, or otherwise called out to indicate the presence of unread items or items otherwise of interest. Clicking on the threads link in quick info list 206 may cause the display of all threads in which the user has participated, while clicking on the DMs list may cause the display in user interface 200 of all the direct messages in which the user is involved. Quick info list 206 may be configurable by the user to add various links to areas of the group-based communication system for quick access, such as a link to view all files shared within the group-based communication system. Channel list pane 204 may also comprise channel and document list 208 listing all channels and documents to which the user has subscribed to or to which the user has been granted access. In some embodiments, channel list pane 204 further includes direct message list 210. Direct message list 210 comprises a list of messages sent from a user directly to another user of the group-based communication system, which may be displayed in channel pane 212 when selected. Direct messages may be sent to one other user or to any number of users. In some embodiments, channel list pane 204 may include synchronous multimedia collaboration session pane 248. Synchronous multimedia collaboration session pane 248 may comprise synchronous multimedia collaboration session controls 250 and synchronous multimedia collaboration session toggle 252. In some embodiments, synchronous multimedia collaboration session pane 248 may display information on which users are participating in a synchronous multimedia collaboration session. Synchronous multimedia collaboration session controls 250 allow a user to mute or unmute, share a screen, and invite other users into the synchronous multimedia collaboration session. In some embodiments, a user selecting to mute during a synchronous multimedia collaboration session may provide the user with an option of providing background music. Users can leave or join a synchronous multimedia collaboration session by actuating synchronous multimedia collaboration session toggle 252. In some embodiments, the synchronous multimedia collaboration session will correspond to a channel or message that the user selected within channel list pane 204.

User interface 200 may further comprise channel pane 212 that displays information related to the currently displayed channel. In some embodiments, within the group-based communication system, communication may be organized into “channels,” each channel dedicated to a particular topic or set of users. For example, Acme Software Engineering company utilizing the group-based communication system may have a channel #general to discuss general company matters and a #proj-1 channel to discuss a live project. Teams within the software engineering firm may have their own channels as well, such as a #devops channel for a DevOps team. Members of a particular channel can post messages within that channel that are visible to other members of that channel together with other messages in that channel. In some embodiments, or for certain selected channels, messages may be visible only to channel members; in other embodiments or for other channels, non-members of a channel may be able to preview messages in a channel without joining. Users may select a channel for viewing to see only those messages relevant to the topic of that channel without seeing messages posted in other channels on different topics.

Channel pane 212 may also include channel header 214, which may display metadata for the currently selected channel, including channel name, channel membership, and channel topic. Channel header 214 may also display channel controls 216 for viewing members of the channel, inviting a new member to the channel, viewing information about the channel, or other channel-related functions. User interface 200 may also include search pane 224. Search pane 224 may allow users to search for content located in the current workspace of the group-based communication system, such as files, messages, channels, members, commands, functions, and the like.

As previously mentioned, channel pane 212 may also include compose pane 226. Compose pane 226 allows users to compose and transmit messages to the members of the channel. Compose pane 226 may have text editing functions such as bold, strikethrough, and italicize. Compose pane 226 may also allow users to format their messages or attach files such as, but not limited to, document files, images, videos, or any other files to share the file or files with other members of the channel.

In some embodiments, conversations in channels may further be broken out into threads. Threads may be used to aggregate messages related to a particular conversation together to make the conversation easier to follow and reply to. For example, a user, J. Smith, in the channel #proj-1 may ask a question pertaining to a specific company policy. Another member of the channel may decide to reply to J. Smith in a thread to keep the conversation grouped together and to keep the response from getting lost in the channel. Under the message to which a user has replied appears thread reply preview 222. Thread reply preview 222 may show information related to the thread, such as, for example, the number of replies and the members who have replied. Thread replies may appear in thread pane 228 that may be separate from channel display 218 in channel pane 212 and may be viewed by other members of the channel by selecting thread reply preview 222 in channel display 218.

In some embodiments, thread pane 228 comprises thread header 230 that may display the channel the thread is associated with. Thread pane 228 also may include scrollable thread display 232 that displays each message sent in the history of the thread. Users participating in the thread may also reply directly to the thread using thread compose pane 234. Thread compose pane 234 may be positioned within thread pane 228 where a user can compose and transmit a reply to the messages in the thread. In some embodiments, thread compose pane 234 shares the features of compose pane 226.

FIG. 2B, by contrast, illustrates user interface 200 when the user is displaying only a document instead of channel information. In embodiments, the document is a collaborative document allowing two or more users to review, edit, comment upon, or otherwise access the document. The collaborative document is described further below.

Where common features or elements are unchanged, they are not discussed separately from their description with respect to FIG. 2A. As illustrated, channel pane 212 and thread pane 228 have been replaced with document pane 236. In some embodiments, document pane 236 may be displayed alongside any other pane, such as channel pane 212. Document pane 236 may comprise document toolbar 238, document controls 240, and document display 242. Document display 242 may display all of the content within the document including unstructured sections and structured sections. The functionality of document pane 236 may be provided by the group-based communication system or by a third-party integration. Although a word-processing document is depicted in document pane 236, any type of document, including a collaborative document discussed below, is contemplated for use with the invention, such as spreadsheet editing, multimedia editing, image editing, and code editing. Each type of document editing may be provided by a different third-party integration. Users can switch the currently displayed document to either another document, a channel, or a direct message by selecting another item in channel list pane 204.

Document pane 236 may include document toolbar 238, which may display icons and menus that allow for the formatting of a document. For example, document toolbar 238 may provide a user the ability to bold, italicize, or underline fonts. In some embodiments, document toolbar 238 may provide users the ability to undo and redo actions. In further embodiments, document toolbar 238 may allow a user to modify the color of text. In still further embodiments, document toolbar 238 may allow a user to insert images, tables, and/or workflows. Document pane 236 may also display metadata for the currently selected document, including document name. Document pane 236 may also include document controls 240 for viewing members with access to the document, inviting a new member to the document, viewing information about the document, or other document-related functions. For example, document controls 240 may display icons indicating which users are currently viewing the document. In some embodiments, document pane 236 may display a workflow status which indicates which workflow step the workflow is currently on. For example, a workflow status may show that the document is currently in the process of an approval workflow step and the document is awaiting approval from a specific user. In further embodiments, the workflow status may show a summary of information within the workflow document. For example, the workflow document may include a table for users to insert their shirt size, and the workflow status may include a summary of the number of shirts of each size that were entered into the table.

### Collaborative Documents

In some embodiments, within the group-based communication system, the document may be a collaborative document, as noted above. A collaborative document may be any file type, such as a PDF, video, audio, word processing document, etc., and is not limited to a word processing document or a spreadsheet. A collaborative document may be modified and edited by two or more users. A collaborative document may also be associated with different user permissions, such that based on a user's permissions for the document (or sections of the document as discussed below), the user may selectively be permitted to view, edit, or comment on the collaborative document (or sections of the collaborative document). As such, users within the set of users having access to the document may have varying permissions for viewing, editing, commenting, or otherwise interfacing with the collaborative document. Document display 242 may display the selected collaborative document if the viewing user has sufficient permissions (e.g., a view permission). In some embodiments, a user of the group-based communication system may edit the collaborative document if they have sufficient permissions (e.g., an edit permission). In further embodiments, a user of the group-based communication system may leave comments on the collaborative document (e.g., a comment permission). As described below, permissions may be automatically assigned to collaborative documents based on, for example, the context of the collaborative document creation.

In some embodiments, collaborative documents may comprise free-form unstructured sections and workflow-related structured sections. In some embodiments, unstructured sections may include areas of the document in which a user can freely modify the collaborative document without any constraints. For example, a user may be able to freely type text to explain the purpose of the document. In some embodiments, a user may add a workflow or a structured workflow section by typing the name of (or otherwise mentioning) the workflow. In further embodiments, typing the “at” sign (@), a previously selected symbol, or a predetermined special character or symbol may provide the user with a list of workflows the user can select to add to the document. For example, a user may indicate that a marketing team member needs to sign off on a proposal by typing “!Marketing Approval” to initiate a workflow that culminates in a member of the marketing team approving the proposal. Placement of an exclamation point prior to the group name of “Marketing Approval” initiates a request for a specification action, in this case routing the proposal for approval. In some embodiments, structured sections may include text entry, selection menus, tables, checkboxes, tasks, calendar events, or any other document section. In further embodiments, structured sections may include text entry spaces that are a part of a workflow. For example, a user may enter text into a text entry space detailing a reason for approval, and then select a submit button that will advance the workflow to the next step of the workflow. In some embodiments, the user may be able to add, edit, or remove structured sections of the document that make up the workflow components.

In embodiments, sections of the collaborative document may have individual permissions associated with them. For example, a collaborative document having sections with individual permissions may provide a first user permission to view, edit, or comment on a first section, while a second user does not have permission to view, edit, or comment on the first section. Alternatively, a first user may have permissions to view a first section of the collaborative document, while a second user has permissions to both view and edit the first section of the collaborative document. The permissions associated with a particular section of the document may be assigned by a first user via various methods, including manual selection of the particular section of the document by the first user or another user with permission to assign permissions, typing or selecting an “assignment” indicator, such as the “@” symbol, or selecting the section by a name of the section. In further embodiments, permissions can be assigned for a plurality of collaborative documents at a single instance via these methods. For example, a plurality of collaborative documents each has a section entitled “Group Information,” where the first user with permission to assign permissions desires an entire user group to have access to the information in the “Group Information” section of the plurality of collaborative documents. In embodiments, the first user can select the plurality of collaborative documents and the “Group Information” section to effectuate permissions to access (or view, edit, etc.) to the entire user group the “Group Information” section of each of the plurality of collaborative documents.

### Identifying Suggested Connections Based on Relationship Graphs

Collaborative tools within a group-based communication system such as channel-based messaging and collaborative documents allow users of the group-based communication system to efficiently work together. As users collaborate within the group-based communication system, collaboration information related to the relationships between the users and how those users work together is generated. This collaboration information can be utilized by the group-based communication system to further improve collaboration. For example, a group of users, such as a marketing team, may often work together within shared collaborative documents. As a means of further improving the marketing team's collaboration, the group-based communication system may suggest to a user that they create a new marketing team channel. The user can then engage with the suggestion to easily set up a new channel and automatically invite all of the members of the marketing team. This collaboration information can be used to suggest new channels, direct messages, synchronous multimedia collaboration sessions, collaborative documents, or workflows which may improve collaboration.

However, collaboration information exists in external third-party platforms as well. Users interact on a large variety of digital platforms for both business and social purposes such as social media, email and other messaging applications, calendar and meeting programs, collaboration platforms, and many other platforms which involve user relationships, interactions, and collaboration. Like the collaboration information internal to the group-based communication system, this third-party collaboration information can be used to enhance collaboration in the group-based communication system. Many of the users of these external third-party platforms also use group-based communication systems. The external collaboration information may contain existing relationships which have not yet been captured or reproduced within the group-based communication system. As such, it is advantageous to the group-based communication system to examine the collaboration information from external sources such that these missing relationships and connections can be suggested to users and reproduced within the group-based communication system to enhance collaboration. The collaboration information can be modeled as a graph, with each external platform having its own graph showing the relationship between all of the users. By unifying the graphs from a variety of third-party platforms, a more complete graph can be created from which new connections between users can be determined and used to suggest collaboration opportunities.

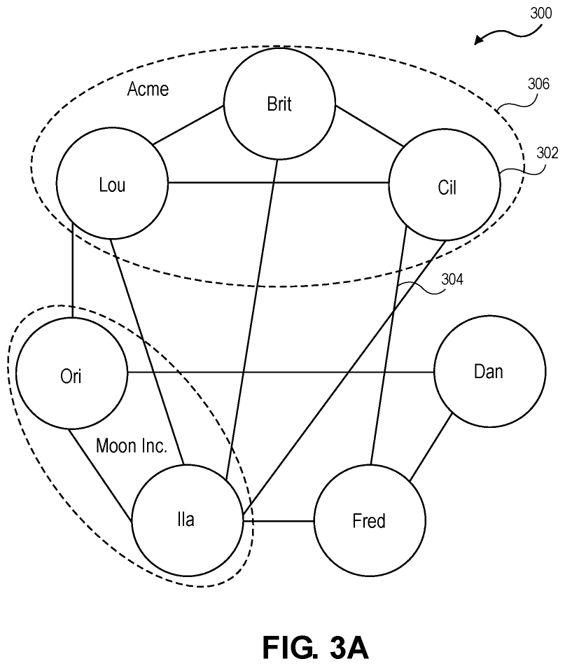

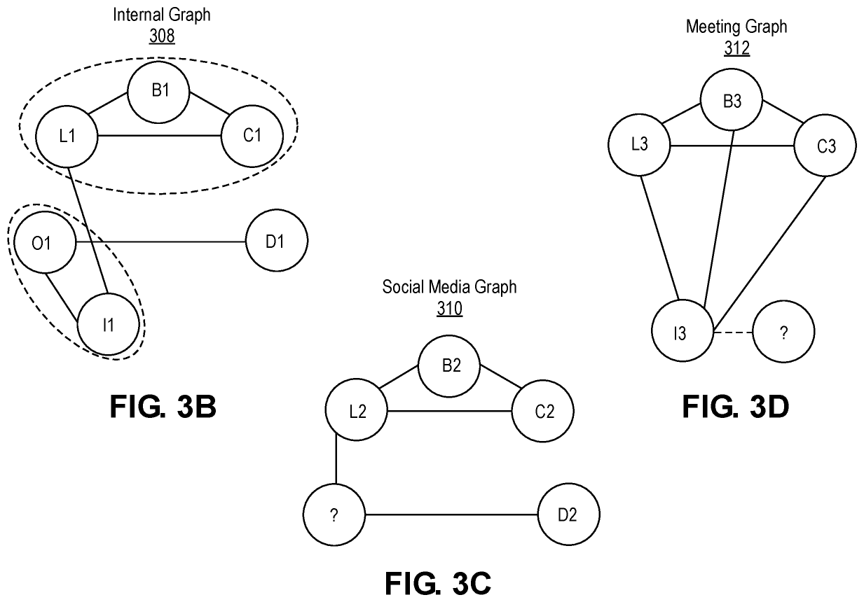

FIG. 3A depicts graph 300, which is made up of a plurality of nodes 302 representing people and a plurality of edges 304 representing connections between those people. Similar graphs exist for digital platforms such as group-based communication systems, social media platforms, contact lists, meetings, business software, business organization charts, or any type of digital connections. For these per-platform graphs, the nodes represent users of that platform, and the edges represent a connection on that particular digital platform. However, nodes for two people who know each other in real life (and whose nodes therefore should share an edge) may not share an edge in a particular per-platform graph if the users are not connected on that platform. Because each per-platform graph is incomplete, combining per-platform graphs from multiple platforms allows a more complete representation of all relationships constructed.

Considering the example relationship graph in FIG. 3A, nodes 302 represent seven individuals: Brit, Cil, Dan, Fred, Ila, Ori, and Lou. This graph corresponds to those seven individuals for the sake of discussion. In some embodiments, nodes 302 may each contain information about a person such as the person's name, age, gender, location, email address, or any other personal information. For example, a node may indicate that Fred is a 75-year-old man living in San Francisco, California. In some embodiments, nodes 302 may each contain business information related to the respective person such as the person's job title, role, company, or organization. For example, a node may indicate that Cil is a senior software developer at Acme.

Any relationship between two people may be represented by edges 304. In some embodiments, edges 304 may comprise additional qualitative or quantitative information related to the connection between nodes 302. For example, an edge between Cil and Fred may contain a high score indicative of a strong relationship between the two users, which may occur when the users interact frequently, are connected on multiple different digital platforms, and have a strong affinity for one another. As another example, an edge may contain directional information such as that Brit is a manager for Cil or that Cil follows Brit on a social media platform. In some embodiments, the lack of an edge between two nodes may indicate that the individuals associated with those nodes have never interacted and that there is no connection between the two individuals.

In some embodiments, nodes 302 may be grouped by organization 306 to show that one or more nodes are associated with organization 306. For example, nodes corresponding to Lou, Brit, and Cil may all be grouped together as they all work at Acme. Collapsing graph 300 to combine nodes for all people at the same organization then represents a relationship graph for organizations rather than individuals. Thus, for example, in the organization relationship graph, there would be an edge between the node representing Acme and the node representing Moon, Inc., because of the relationships between the employees in the individual relationship graph.

FIG. 3B depicts a first per-platform graph representing connections between users on a particular platform. For the sake of illustrating the operation of embodiments of the invention, assume internal graph 308 represents the existing connections between users on the platform for which new suggestions are to be generated. Internal graph 308 is thus a subgraph of graph 300, with nodes corresponding to a subset of nodes 302 and edges corresponding to a subset of edges 304. For example, Brit from graph 300 corresponds to B1 in internal graph 308, Cil from graph 300 corresponds to C1 in internal graph 308, and so on. In some embodiments, internal graph 308 may be the graph constructed within a group-based communication system representing the connections between users. For example, two users within a group-based communication system may be connected if they belong to the same organization, have corresponded via a direct message or multi-person direct message, belong to the same channel, or any combination thereof. In some embodiments, internal graph 308 may include organization groupings. In further embodiments, a graph may store additional contextual information about either the nodes, edges, or the graph as a whole. For example, internal graph 308 may store information regarding each node's privacy or permissions settings.

FIG. 3C depicts a second per-platform graph representing connections between users on another platform. For the sake of illustrating the operation of embodiments of the invention, assume social media graph 310 represents connections between users on some social media platform. As depicted, the set of users in social media graph 310 is overlapping the set of users in internal graph 308. Social media graph is thus also a subgraph of graph 300 with nodes corresponding to a subset of nodes 302 and edges corresponding to a subset of edges 304. For example, Brit from graph 300 corresponds to B2 in social media graph 310, Cil from graph 300 corresponds to C2 in social media graph 310, and so on. Social media graph 310 is an example of an external graph which exists outside of the group-based communication system. An external graph may include edges between nodes that are not connected in internal graph 308. Because these users have an existing relationship via the social network, a connection between the users can be suggested in the group-based communication system. In other words, data from the external graph may be used to extend the internal graph so that it is closer to graph 300 in the sense that it contains more of the edges, nodes, and/or information.

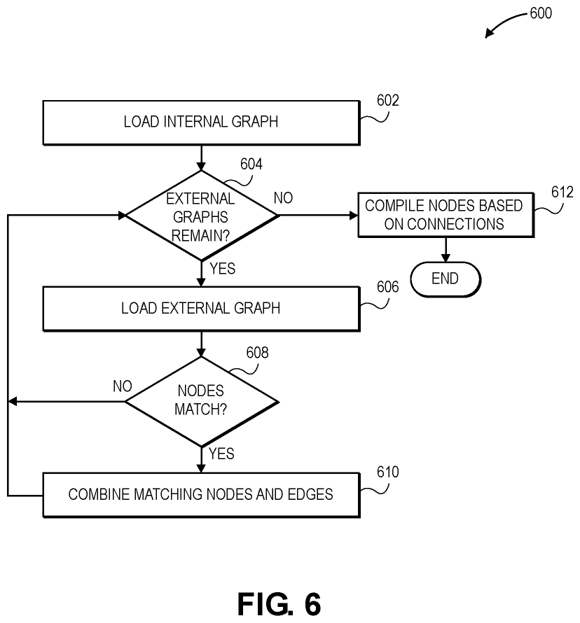

In some cases, social media graph 310 may contain unidentifiable nodes which may not initially be matched to any node from internal graph 308, but which nonetheless may correspond to the same person. For example, a user may use a different name or email on a social media platform than they use on other platforms. In these instances, the node may need to be matched by additional node information or based on the connections using pattern matching or machine learning techniques, as discussed below at FIG. 6. Social media graph 310 may include additional information on the relationships between the nodes such as how long two nodes have been connected, a number of pictures the two nodes share, and how many mutual friends or connections exist between two nodes. For example, an edge between a node associated with Brit and a node associated with Cil may store information relating to how many pictures exist in which both Brit and Cil have been identified or tagged together. In some embodiments, the amount of interactions between two nodes may also be stored within the nodes, with the edge, or both.

FIG. 3D depicts a third per-platform graph representing a third set of connections between users. Continuing the example above, assume that meeting graph 312 depicts connections in the form of the users attending the same meeting(s). For example, the meeting may be scheduled using a calendar service, and the third platform may be that calendar service. Alternatively, the meeting may be a teleconference or videoconference scheduled through a conferencing platform, which would be the third platform. Similar to social media graph 310, meeting graph 312 another subgraph of graph 300 with nodes corresponding to a subset of nodes 302 and edges corresponding to a subset of edges 304. As depicted, the set of users in meeting graph 312 is overlapping the set of users in internal graph 308 and the set of users in social media graph 310; however, per-platform graphs with non-overlapping sets of users are also contemplated. For example, Brit from graph 300 corresponds to B3 in meeting graph 312, Cil from graph 300 corresponds to C3 in meeting graph 312, and so on. For meeting graph 312, edges may indicate that the users were invited to and attended the meeting. In some embodiments, edges may be weighted differently if the user was invited to the meeting but did not attend, was invited to the meeting and attended, or was invited to the meeting but declined. For example, node 13 (representing Ila) may be connected to an unknown node because a user with an unknown email address was invited to a meeting but did not attend the meeting. Meeting graph 312 may contain additional information about the meeting such as the time and date of the meeting, the location of the meeting, the type of the meeting such as in person, virtual or remote, telephonic, or videoconference, and the total number of attendees and invitees. In some embodiments, meeting graph 312 may represent synchronous multimedia collaboration sessions or similar meetings within a group-based communication system.

Like social media graph 310, data from meeting graph 312 may be used to augment the internal graph to so that it is closer to graph 300 in the sense that that it contains more of the edges, nodes, and/or information, and data can be combined from a plurality of such external per-platform graphs. The newly augmented internal graph may have edges not initially present in internal graph 308. For example, it may be determined that a connection exists between Lou and Ori based on determining that the unknown node in social media graph 310 corresponds to Ori and that a connection exists between Ori and Lou in social media graph 310. These connections which are present in the combined graph but missing in internal graph 308 may be suggested to a user such that the user may add the connection in the group-based communication system. For example, the connection between Lou and On may be suggested to Lou such that Lou can create a direct message or a shared channel with On.

### User Interfaces for Embodiments of the Invention

Once the external graphs have been processed and combined with the internal graph of the group-based communication system, the combined graph will contain many relationships which do not yet exist within the group-based communication system. These missing relationships may be further analyzed to suggest actions to users which can improve collaboration within the group-based communication system. In some embodiments, the group-based communication system may leverage the combined graph to suggest new channels or direct messages to a user, allowing the user to collaborate with people whom the user already has an existing relationship with outside of the group-based communication system. The combined graph may also be leveraged to suggest users to add to collaborative documents or synchronous multimedia collaboration sessions.

Existing relationships may also be enhanced with the additional relationship information from the external graphs to provide additional insights and allow further refinement of suggestions for enhanced collaboration. In further embodiments, the group-based communication system can leverage the combined graph to refine suggestions. In still further embodiments, the relationship between users in the combined graph may be used when suggesting results to a user during a search or autofill suggestion, such as in a collaborative document when adding users to a task or workflow. The additional relationship information may also be used to inform the order and timing of suggestions. For example, a strong relationship may be prioritized as a suggestion over weaker relationships. As another example, additional relationship information may include that two users who have previously worked together on one project are now working together on a second project and therefore make suggestions regarding the second project. As yet another example, the additional relationship information may include negative relationship aspects and therefore be used to inhibit suggesting certain connections between users. The following illustrates some use cases of suggestions to users.

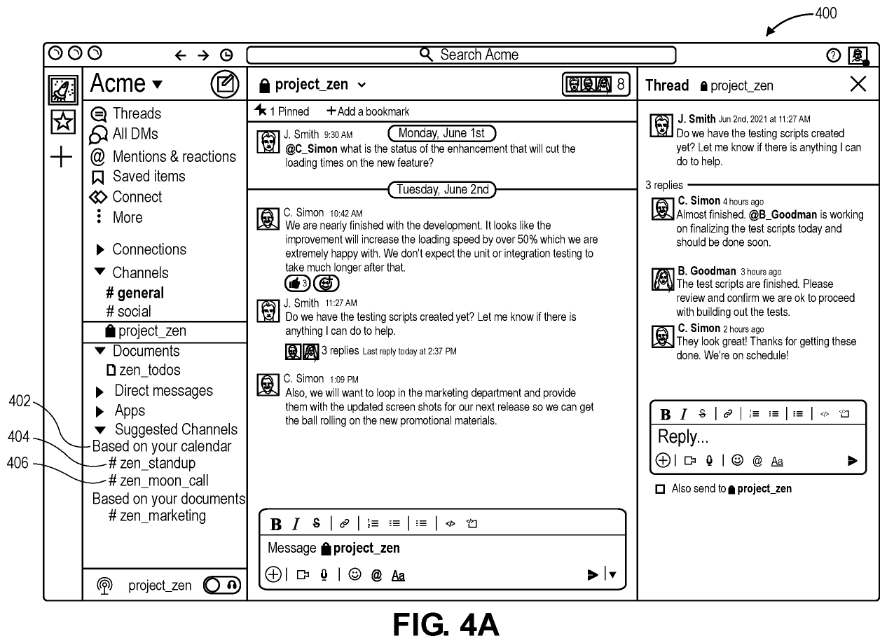

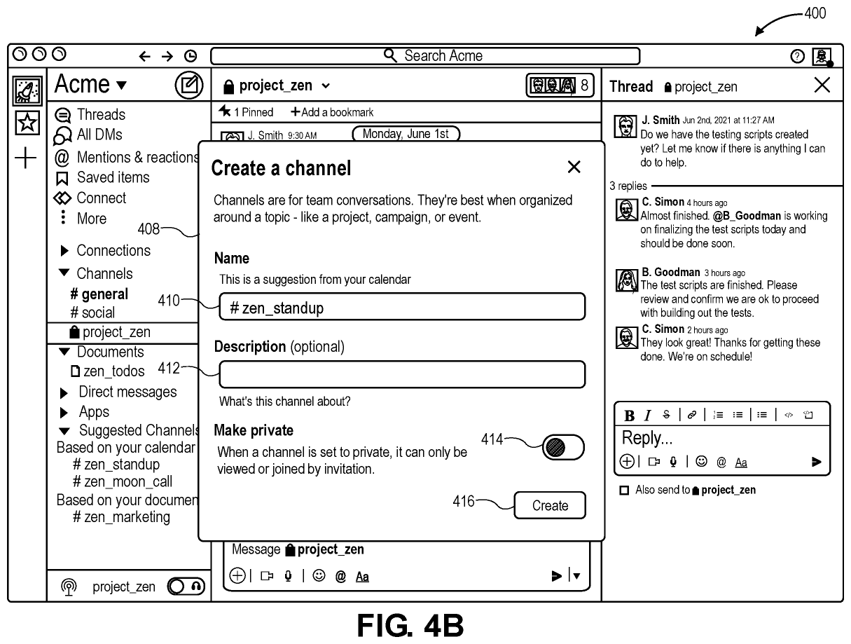

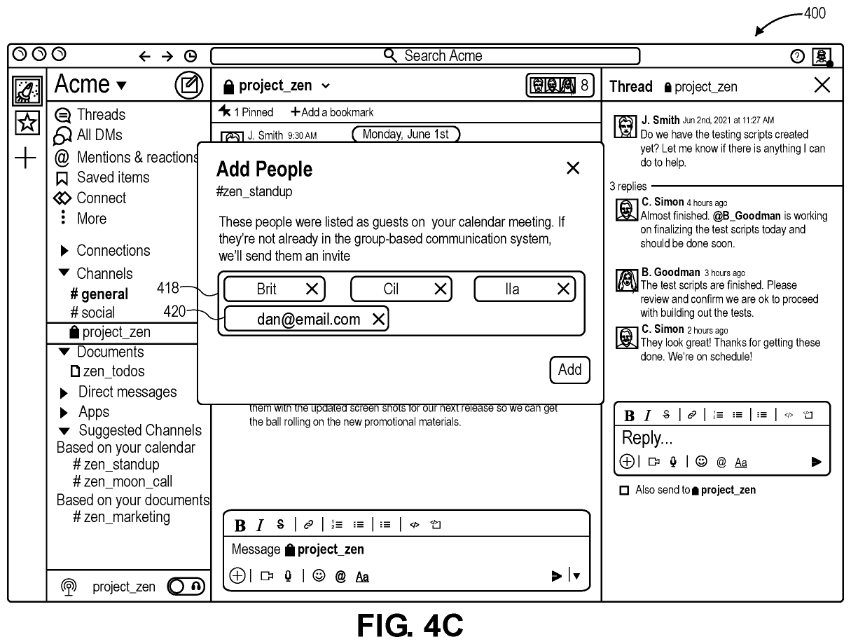

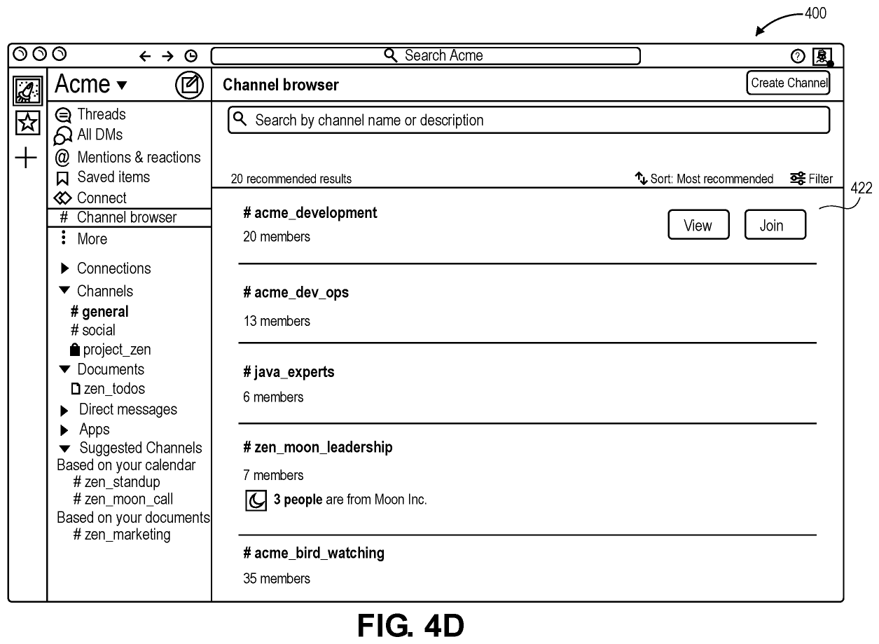

FIG. 4A illustrates user interface 400 for suggesting connections to a user. In some embodiments, suggested connections may include suggested channels 406 which are presented to a user in a pane of user interface 400 in suggested channels section 402. Suggested channels may be existing channels to which the user does not (but should) belong, or channels which do not (but should) exist. In further embodiments, suggested connections may include direct messages or multi-person direct messages with suggested users. In other embodiments, suggested connections may include collaborative documents or synchronous multimedia collaboration sessions and may be suggested at the time the collaborative documents or synchronous multimedia collaboration sessions are created or actively in use. Broadly, suggested connections (such as suggested channels 406) may be determined based on analysis of graphs as discussed at FIGS. 3A-3D. In some embodiments, suggested channels section 402 may only be visible to the user at certain times when it is determined that the user is more likely to create or join a channel based on the suggestion. In further embodiments, only certain users within the group-based communication system may be able to view particular channels in suggested channels section 402. For example, in some organizations only users of the group-based communication system with administrator privileges may be able to create new channels and therefore only administrators may be presented with suggested new channels in suggested channels section 402.

In some embodiments, suggested channels section 402 may include suggestion reasoning 404. Suggestion reasoning 404 may include details as to why a suggested channel 406 is being recommended to the user. For example, suggestion reasoning 404 may tell the user that one or more of suggested channels 406 are being recommended based on the user's calendar. In this example, the user's calendar data may be used to analyze a meeting graph which is then analyzed to determine new channels for the user. Continuing the above example, the user may attend a weekly meeting with other users. This weekly meeting may be suggested to the user as a new channel which could replace the need for the weekly meeting by allowing the user's to collaborate asynchronously or synchronously as needed. The users to be suggested for the channel may be based on the users who were invited to the meeting, and the name of the channel may be based in part on a subject or title of the weekly meeting.

FIG. 4B illustrates user interface 400 for creating a new channel based on a channel suggestion. In some embodiments, upon actuating a new channel of the suggested channels 406, the user may be presented with channel creation interface 408. Channel creation interface 408 may assist the user with the channel creation process within the group-based communication system including setting information and settings for the channel and inviting other users to the channel. Channel creation interface 408 may comprise inputs for channel name 410 and channel description 412. In some embodiments, channel creation interface 408 further comprises private channel toggle 414 and create channel button 416.

In some embodiments, channel name 410 and/or channel description 412 may be pre-populated based on the data and graphs used to suggest the channel. For example, a suggested channel may be based on a meeting graph corresponding to a meeting, and the meeting's subject may be used as the name of the channel and the meeting's description may be used as the description of the channel. As another example, if a meeting recurs daily, then channel name 410 may include “daily” in the name, such as for a channel related to a daily standup. Additional information related to the graph, such as the time, location, or date for a meeting may also be used in channel name 410 or channel description 412. In some embodiments, information related to the organizations may also be included in channel name 410 or channel description 412. For example, if the corresponding graph indicates a document was shared between Acme and Moon Inc., then channel description 412 may include an indication that the channel was created to further collaboration between the two organizations.

In some embodiments, private channel toggle 414 may allow a user to decide if a channel should be private or public. In further embodiments, private channel toggle 414 may initially be set based on the data used to suggest the channel. For example, a suggested channel may be set to public if it was based on a shared document which was also set to public and could be accessed by anyone with the link. As another example, a channel may be set to private if it was based on a shared document which was set to private. In some embodiments, the channel may be set to private based on the number of users suggested for the channel, information on the users suggested to the channel, relationships between the users suggested to the channel, or any other information which was used to suggest the channel. For example, a suggested channel containing a suggested user with an executive role may cause the suggested channel to initially be set to private.

In some embodiments, create channel button 416 may cause the new channel to be created based on the channel name 410, channel description 412, and private channel toggle 414. In other embodiments, actuation of create channel button 416 may advance through the channel creation process, including allowing the user to invite additional users as discussed at FIG. 4C. In some embodiments, all newly created channels may be sent to an administrator within the group-based communication system for approval before the channels are created. For example, actuation of create channel button 416 may initiate a workflow in which the channel information may be sent to an administrative user as a task for approval.

FIG. 4C illustrates user interface 400 for adding users to a channel. In some embodiments, channel creation interface 408 may further comprise user selection 418 which enables the user to add new suggested users 420 to the new channel. In other embodiments, new users may be suggested for adding to an existing channel to which the current user belongs. For example, in addition to an existing channel being recommended to a non-member, current members of that channel may be suggested to add the non-member. In some embodiments, new suggested users 420 may be either existing users of the group-based communication system or external users who do not yet have a group-based communication system account. In some embodiments, new suggested users 420 without a group-based communication system may be added by email. For example, a user's email address may be added which may cause the user to receive an email with a link to join the group-based communication system and to be invited to the new channel. In some embodiments, new suggested users 420 may include an indication for which users already have group-based communication system accounts.

FIG. 4D illustrates a mode of user interface 400 for suggesting existing channels to a user. As described above, in some embodiments, the analysis of the graphs discussed at FIGS. 3A-3D may determine that a user may be interested in joining existing channels. For example, a channel may exist which corresponds to a weekly standup meeting to which the user is invited, but the user may not be a member of the channel in the group-based communication system. In such a case, suggested existing channels 422 may be presented to the user. Suggested existing channels 422 may each comprise a channel name and an indication of how many users are present in the suggested existing channels 422. In further embodiments, suggested existing channels 422 may be channels shared with external organizations and include an indication of how many users in the channel are from the external organization. For example, a channel may exist for the leadership between Acme and Moon Inc. and include an indication that there are 7 total members, 3 of which are from Moon Inc. In still further embodiments, suggested existing channels 422 may include buttons that when actuated allow a user to join or view suggested existing channels 422.

### Operation of Embodiments of The Invention

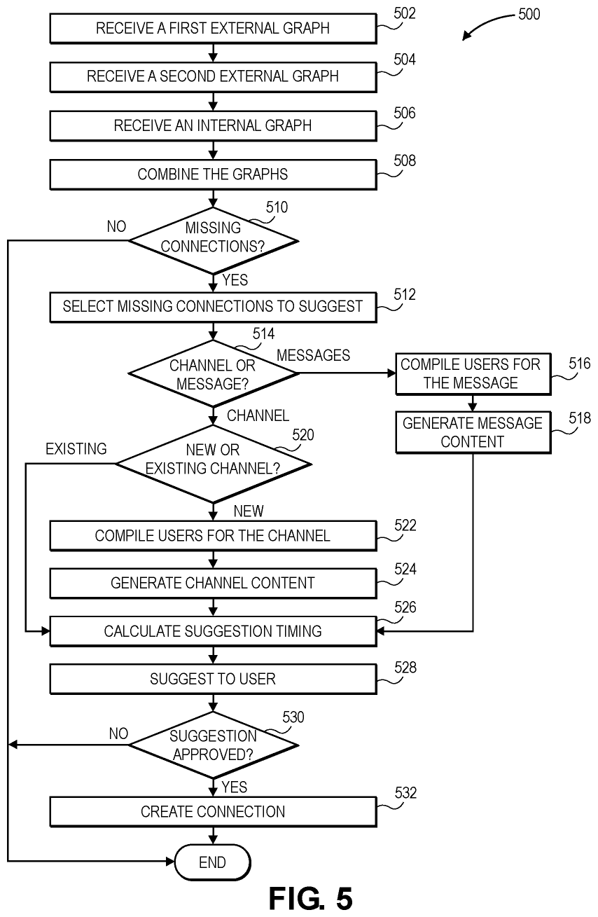

FIG. 5 depicts flowchart 500 for suggesting connections to a user. At step 502, a first external graph is received. Similarly, at step 504, a second external graph is received. Both the first and second external graph may be any data indicating relationships among users, as discussed at FIGS. 3A-3D. In some embodiments, the data may be received in any format and later processed into a graph. For example, the data may include a dataset of meetings, including who was invited to each meeting, who attended each meeting, the relevant participation of each user in each meeting, and the attendance time of each user in each meeting. Any data showing relationships between users is contemplated. In some embodiments, the external graphs may be received via one or more API calls to request the data. In further embodiments, the external graphs may be reconstructed from mined data. In still further embodiments, portions of the external graphs may include partially anonymized data or data otherwise modified for privacy concerns. The first external graph and second external graph may be based on social media platforms, business platforms, meetings or similar calendar-based systems, communication systems such as email or instant messenger, business platforms focused on networking, group-based communication systems, or similar. Although the term external is used herein to distinguish per-platform connection data from the current set of connections being augmented, per-platform graphs from the same platform are also contemplated. For example, connection data in the form of common participation in synchronous multimedia collaboration sessions on a group-based communication system may be used to augment the connection graph for that group-based communication system and suggest new connections. In some embodiments, both the first external graph and second external graph may be the same type of graph. For example, multiple per-platform graphs from social media networks may be used to augment the connection graph. Although the method described below is discussed with respect to two external graphs, the use of any number of external graphs is contemplated.

At step 506, an internal graph is received, representing an internal system for which connections may be suggested. In some embodiments, the internal graph may be a group-based communication system connection graph. The internal graph may represent the current users, connections, and relationships present in the group-based communication system. In some embodiments, the internal graph may further represent all possible users and connections which the internal system is aware of, regardless of if those connections or users are currently present within the internal system. For example, a user may have sent an invite to an external email address inviting an external user to join the group-based communication system. Although the external user has not yet joined the group-based communication system, the connection between the user and the external user may still be present in the internal graph based on the user sending the invitation to the external email address.

At step 508, the first external graph, second external graph, and internal graph are combined into one combined graph. Combining the graphs may comprise matching the nodes which correspond to the same users and ensuring that all connections are included as edges in the combined graph. In some embodiments, there may be a similarity threshold for determining whether or not nodes represent the same user. For example, two nodes which share the same username may not be considered a match in some embodiments unless the two nodes also share a matching email address. An exemplary method for combining graphs is discussed below at FIG. 6. In some embodiments, once the graphs are combined, the combined graph may replace the internal graph such that all of the information from the external graphs is saved within the group-based communication system. This allows the group-based communication system to continuously expand its understanding of all relationships between the users.

At step 510, the combined graph generated at step 508 is compared to the internal graph received at step 506 to determine if there are any connections present in the combined graph which are missing from the internal graph. These missing connections represent possible connections which may be suggested to the user for adding to the group-based communication system. In some embodiments, the missing connections may be represented by edges which were not present in the internal graph. In other embodiments, the missing connections may be represented by a combination of edges and nodes which were not present in the internal graph. If there are no connections from the combined graph missing in the internal graph, the workflow ends. Otherwise, the workflow proceeds to step 512.

At step 512, one or more missing connections identified at step 510 are selected. The selected connections are the connections which may be suggested to the user. In some embodiments, the connections may be selected based on which connections are most likely to be accepted by the user. For example, each missing connection may be given a likelihood of acceptance score. In some embodiments, the likelihood of acceptance score may be generated using a machine learning model trained to calculate how likely a user is to accept a suggestion. The likelihood of acceptance may vary by user, as some users may be more likely to accept suggestions regardless of what the suggestion is. For example, a new user to a group-based communication system may be more eager to create new channels than an existing user. As another example, a user may have a role in an organization in which the user is responsible for creating connections for the organization within the group-based communication system.

In some embodiments, the likelihood of acceptance (and therefore of the system suggesting the missing connection) may be based on features of the relationship. For example, a relationship between two users may be based on one or more meetings attended by both users. The likelihood of acceptance may be based in part on one or more of the total number of meetings, the size of the meetings, who organized the meetings, how often the meetings occurred, if the meetings were reoccurring, and other relationships of additional people who attended the meetings. In some embodiments, these features may be used within the machine learning model to calculate the likelihood of acceptance. In further embodiments, machine learning models may be modified to consider or not consider distribution lists or other large scale invitations to events or an average number of invitations or events.

At step 514, the selected connections are determined to be suggested as either a channel or a message, including a direct message or multi-person direct message. In some embodiments, the determination may be based in part on the number of connections. The connection may be based in part on the source of the suggestion, such as what type of graph the connection was present in. For example, if the connection was based on a recurring meeting between users then that may indicate that the collaboration is ongoing and therefore may be better suited to a channel. As another example, the connection between users may be one-to-one, such as when the users connection is collaboration on a document, and therefore collaboration between the users may be better suited to a message. In some embodiments, the decision to suggest the connection as a channel or a message may be based in part on the likelihood that the user may accept the connection. For example, a user with an affinity for creating channels may be more likely to accept a specific suggested channel than they may be to initiate a new message. If the missing connection is determined to be suggested as a message, the flowchart proceeds to step 516. Otherwise if the missing connection may be suggested as a channel, the flowchart proceeds to step 520.

In further embodiments, selected connections may alternatively or additionally be suggested as synchronous multimedia collaboration sessions or collaborative documents. For example, it may be determined based on the relationship between two users being based on a document that the best means for collaboration is a collaborative document. As another example, if it is determined that the relationship between multiple users is unlikely to be recurring, the selected connection may be a synchronous multimedia collaboration session to allow for an ephemeral means of collaboration.

At step 516, the users are compiled for the message. In some embodiments, the message may be a direct message between the user who may receive the suggestion and one other user. In other embodiments, the message may be a multi-person direct message between the user who may receive the suggestion and two or more users. Users may be determined based on the connections present in the combined graph, discussed at step 508. In some embodiments, additional users may be added to a multi-person direct message to increase the likelihood of acceptance. For example, multiple users from Acme may be added to a multi-person direct message to be suggested to a user from Moon Inc. because all of the users attended a networking event together.

At step 518, content for the message may be generated. In some embodiments, message content may include a draft message for the user to send to initiate the conversation. For example, a draft message may include an introduction from a user to the other users in a multi-person direct message alerting the users that the message was created because all of the users recently worked together on a shared document to discuss a particular software feature. In some embodiments, the draft content must be accepted by the user after the user accepts the suggestion. In some embodiments, the content may be an attachment to the message. For example, a connection which is suggested based on multiple users sharing a document may attach the document to the message as further context.

At step 520, it is determined if the suggested channel is a new channel or an existing channel. For example, a new channel may be best suited when the purpose or topic of collaboration does not yet exist in the group-based communication system. However, an existing channel may already exist related to the topic which may be improved by adding the user to the existing channel. For example, a channel related to a weekly standup meeting at Acme may already exist within the group-based communication system. When a new software developer joins Acme they may be invited to a meeting corresponding to the weekly standup meeting, causing the new software developer to appear as a missing connection. However, this connection may be better served by the existing channel and therefore the new software developer may receive a suggestion to join the existing channel instead of creating a new channel which may be duplicative.

In some embodiments, the decision of whether a channel should be a new channel or an existing channel may be based on the number of connections which already exist related to the missing connection. For example, if an existing channel contains twenty users and the new channel may be the same twenty users plus an additional user, the group-based communication system may be better served by suggesting the additional user be added to the existing channel rather than creating a new channel. In some embodiments, the decision of whether a channel should be a new channel or an existing channel may be based on the user's permissions or role. For example, some users may not have permission to create a new channel and may instead be recommended to join one or more existing channels corresponding to the missing connections. If the channel is determined to be an existing channel, the flowchart proceeds to step 526. Otherwise, the flowchart proceeds to step 522.

At step 522, the users are compiled for the new channel. Users may be determined based on the connections present in the combined graph, discussed at step 508. In some embodiments, users may be added to the new channel to increase the likelihood of acceptance. For example, a new channel may add additional users to further differentiate the new channel from an existing channel. In some embodiments, specific users may be intentionally omitted from a new channel. For example, if a channel is based on an existing meeting then a user which only sent out the invite but did not attend the meeting may be omitted as they are merely a scheduler and not a participant. As another example, a high-level executive who was invited to the meeting may not be included if it is unlikely that the user would choose to invite the high level executive or that the high level executive would choose to join the channel.

At step 524, content for the new channel is generated. In some embodiments, channel content may include one or more posts which may be used to pre-populate the new channel. In some embodiments, the channel content may include a suggested post from the user creating the new channel introducing themselves and providing context as to why the channel was created. For example, a suggested new channel based on an existing meeting may generate a suggested post explaining that the new channel is based off of the existing meeting. In some embodiments, the suggested posts may provide an introduction from the user and prompt other users to introduce themselves as well.

In some embodiments, the suggested content may include content related to files, the channel description, or other similar context for the newly created channel. In some embodiments, files associated with the new channel may be uploaded to the channel. For example, if a channel was created based in part on users collaborating on a shared document, a version of the shared document may be automatically uploaded to the channel. The channel description may similarly be automatically created based on the connections. In some embodiments, the user may be prompted to confirm some or all of the suggested content.

At step 526, timing is determined for the suggestion. In some embodiments, the suggestion may be made to the user at a time when the user may be more likely to accept the suggestion. For example, if the suggestion is a new channel based on an existing meeting, then the suggestion to add the channel may occur close in time to when the meeting typically occurs when it may be top of mind to the user. As another example, suggestions may be targeted when the user is particularly active within the group-based communication system as a way that the user can be more efficient. As yet another example, suggestions may be targeted when the user is not particularly busy so that the user may have time to properly analyze and process the suggestion.

In some embodiments, the timing may be determined based on a machine learning model. A machine learning model may be trained to predict how a user responds when prompted with suggestions at various times and suggest a specific time for the suggestion. In some embodiments, the timing may be an actual time such as 8:00 am or 3:00 pm. In further embodiments, the timing may be based on an event. For example, the suggested timing may be for thirty minutes after the user first logs in to the group-based communication system. As another example, the suggested timing may be for one hour before a calendar event or meeting associated with the user. In some embodiments, the timing may be based in part on the recency of the relationship information.

At step 528, the suggestion is made to the user. In some embodiments, the suggestion may be made to the user at a time based on the timing determined at step 526. The suggestion may be made to the user via a notification in the group-based communication system. In some embodiments, the suggestions may be made within a user interface of the group-based communication system. For example, a new suggested channel may be made in the navigation pane, as discussed at FIG. 4A or an existing channel may be suggested via a channel browser, as discussed at FIG. 4D.

In some embodiments, the suggestion may be presented to the user in a way that increases the likelihood of acceptance. For example, the other users in the suggestion may be sorted by the user's affinity towards the other users to emphasize the other users which may make the user more likely to accept the suggestion. In some embodiments, additional context related to the suggestion may be offered to the user. For example, a suggested channel may inform a user that the channel is suggested because of the user's relationship with a specific person.

At step 530, the user may approve or reject the suggestion. In some embodiments, the user may modify the suggestion before accepting it, such as changing information related to the suggestion or the other users involved as discussed at FIGS. 4A-4C. The user's approval or rejection of a suggestion may modify what other suggestions are made to the user. For example, if a user routinely denies all suggestions then the user may stop receiving suggestions. As another example, if a user creates a large amount of channels after they are suggested, then more channels may be suggested to the user. If the user accepts the suggestion, then the connection may be created at step 532 and the combined graph may be updated to include the information that the connection was approved. Otherwise, the rejection may be stored as information within the combined graph regarding the suggested connection to inform future suggestions and the workflow ends.

At step 532, the connection is created. In some embodiments, creating the connection involves creating the channel or sending a message. Users of the group-based communication system who are a part of the newly created connection may receive a notification within the group-based communication system. In some embodiments, individuals who are a part of the connection but not yet on the group-based communication system may receive a customized invitation to join the group-based communication system. In further embodiments, the customized invitation may include information about the user who accepted the suggestion and the related connection.

FIG. 6 depicts flowchart 600 for an exemplary method for combining graphs. At step 602, the internal graph is first loaded. The internal graph may represent the current connections present in the group-based communication system. In some embodiments, the internal graph may be a result of previously combining external graphs and continue to expand as this process is repeated. In further embodiments, the internal graph may be modified or selected, such as by a machine learning model or other preprocessing, to create an optimal graph for flowchart 600.

In some embodiments, the internal graph may be a subset of the connections in a group-based communication system. The subset may be selected to minimize the computational time, since many connections in the group-based communication system may be irrelevant for a particular user or organization. In some embodiments, a subset of information about the users and connections may be used. In further embodiments, some of the information about the users and connections may be limited based on user privacy or similar permissions set by the user. For example, a user may have disabled the ability to find connections based on the user's email, so this information may be omitted.

At step 604, it is determined if any external graphs remain to be processed. The method may iterate through any number of external graphs until all external graphs have been processed. If all of the external graphs have been processed, the method may advance to step 612. Otherwise if external graphs remain to be processed, the method may advance to step 606. In some embodiments, the external graphs may be stored in a queue for processing. The order of the queue may be determined to optimize the processing. In some embodiments, the external graphs may be broken in smaller graph subsets to improve processing efficiency.

At step 606, an external graph is loaded. The external graph to be loaded may be selected as the external graph at the front of the processing queue. In some embodiments, the loaded graph may be added to the internal graph to update the internal graph with the new edges and nodes from the external graph. For example, an external graph relating to a set of calendar invites may be loaded to decipher new connections. The external graph may contain some nodes and edges which correspond to nodes and edges already present in the internal graph.

At step 608, the graph is checked for matching nodes. In some embodiments, a matching node indicates that two of the nodes correspond to the same user. For example, the internal graph may have a node for a user Ori with an email address ori@example.com. The external graph may contain a node indicating that a user with an email address of ori@example.com was in a meeting with Cil. Because the email address from the internal graph node matches the email address from the external graph node, it may be determined that the nodes match. If one or more nodes match, then the flowchart proceeds to step 610. Otherwise, the flowchart proceeds to step 604.

In some embodiments, two nodes may be considered a match based on a similarity score meeting a similarity threshold. The similarity score may be calculated based on any predetermined metric or a machine learning model. For example, two nodes each containing the same full name and address may have a high similarity score, whereas two nodes each containing a matching full name may have a medium similarity score. The similarity score may be based on the specific types of information matching, the amount of information matching, or the closeness of matching. For example, a node with the name Joe Brown may have a lower similarity score to a node with the name Joseph Brown than if both nodes contained an identical name. The similarity threshold may be predetermined and may be context specific. For example, information from an external graph known to have accurate information may require a lower threshold than a less reputable external graph.

At step 610, the matching nodes and edges are combined. The information from the external graph matching node may be added to the internal graph matching node. For example, an address for a user which was in the information in the external graph matching node may be added to the information in the internal graph matching node. In some embodiments, information between two matching nodes may be merged. For example, if the internal graph matching node had the name J. Smith and the external graph matching node had the name John S., the full name of John Smith may be added to the internal graph matching node.

In some embodiments, the edges from the external graph matching node may be added to the internal graph matching node. For example, the external graph may have shown that Cil and Ila had a connection based on attending a meeting together, but that no such connection exists in the internal graph. The connection between Cil and Ila may then be added to the internal graph for the purposes of suggesting a connection. In some embodiments, the edge representing the connection may contain information about the connection, such as the source of the connection. For example, the edge between Cil and Ila may contain that the connection was added because of the shared meeting. In some embodiments, the edges may already exist in the internal graph but the weight or score of the connection may be adjusted based on the corresponding connections in the external graph.

At step 612, the nodes are compiled based on the connections, or edges. Some of the nodes from the external graph may correspond to the internal graph nodes, but the information at the nodes may not be enough to determine that the nodes are a match. When calculating the similarity score based on the information, it may be below the necessary similarity threshold. However, an analysis of the connections may indicate that the nodes are a match. In some embodiments, the nodes may be determined to be a match when they have a sufficient amount of connections in common. In further embodiments, two nodes may be a match when they have identical edges. In still further embodiments, cluster analysis may be used to inform how the nodes should be compiled. Organizing the nodes into clusters may help to reveal additional relationships between the nodes, such as which nodes may correspond to users working on the same teams, for the same companies, in related industries, or are in some other way related.

For example, an internal node may correspond to Dan but not contain his email. Dan may be connected to Ori and Fred in the internal graph. In an external graph associated with a meeting, an external node may have no identified user and contain an email address not found in the internal graph. The external node may be connected to Ori and Fred in the external graph. Once the external and internal graphs are combined, the combined graph may have two nodes connected to both Ori and Fred. Because both nodes share the same connections, it may be inferred that both nodes correspond to Dan, and the nodes may be compiled together such that the new node for Dan contains the email address from the previously external node.

In some embodiments, machine learning may be used to find matching nodes based on the connections. Finding corresponding nodes based on connections is a difficult problem which is particularly well suited to machine learning. A machine learning model may be trained to analyze graphs and combine nodes that share connections. The machine learning model may take as an input a graph and produce a revised graph in which some of the nodes have been compiled. In some embodiments, the weights or information related to the edges may also be used in the machine learning model to find matching nodes. In further embodiments, machine learning models can consider information related to calendar events such as which users attended the event, which user organized the event, the user's response status to the event such as confirmed, tentative, or declined, the visibility of the event such as public, private, or confidential, or the reoccurrence of the event such as daily, weekly, or monthly. Machine learning models may include approximately ten features, approximately twenty features, approximately one hundred features, or more than one hundred features due to the complexity of input data. Cluster analysis of shared event participation may also be used to further refine machine learning models. Once all the graphs have been combined and the corresponding nodes collapsed, the method ends, and the resulting graph can be used to suggest new connections as described above with respect to FIG. 5.

1. A method for adding connections for a user, the method comprising:
receiving, from a first external source of relationship data, a first external data set representing relationships among a first plurality of users;
receiving, from a second external source of relationship data, a second external data set representing relationships among a second plurality of users;
receiving an internal data set representing relationships among a plurality of internal users;
wherein the first plurality of users, the second plurality of users, and the plurality of internal users represent distinct overlapping sets of users;
generating a combined data set representing relationships between the first plurality of users, the second plurality of users, and the plurality of internal users; and
in response to determining that the combined data set contains one or more relationships not included in the internal data set between the user and one or more unconnected users:
presenting, to the user, a suggested virtual space including the user and the one or more unconnected users;
receiving, from the user, an action to engage with the suggested virtual space; and
in response to detecting the action, creating the suggested virtual space.

2. The method of claim 1, further comprising inviting the one or more unconnected users to the suggested virtual space.

3. The method of claim 1, further comprising adding the one or more unconnected users as collaborators to a collaborative document within the suggested virtual space.

4. The method of claim 1, further comprising establishing a synchronous multimedia collaboration session corresponding to the user and the one or more unconnected users and the suggested virtual space.

5. The method of claim 1, further comprising launching the suggested virtual space within a user interface associated with a group-based communication system.

6. The method of claim 1, further comprising providing a suggested message from the user to the one or more unconnected users in the suggested virtual space.

7. The method of claim 1, further comprising saving the combined data set within a group-based communication system as a new internal data set.

8. One or more non-transitory computer-readable media storing computer-executable instructions that, when executed by at least one processor, perform a method for adding connections for a user, the method comprising:
receiving, from a first external source of relationship data, a first external data set representing relationships among a first plurality of users;
receiving, from a second external source of relationship data, a second external data set representing relationships among a second plurality of users;
receiving an internal data set representing relationships among a plurality of internal users;
wherein the first plurality of users, the second plurality of users, and the plurality of internal users represent distinct overlapping sets of users;
generating a combined data set representing relationships between the first plurality of users, the second plurality of users, and the plurality of internal users; and
in response to determining that the combined data set contains one or more relationships not included in the internal data set between the user and one or more unconnected users:
presenting, to the user, a suggested virtual space including the user and the one or more unconnected users;
receiving, from the user, an action to engage with the suggested virtual space; and
in response to detecting the action, creating the suggested virtual space.

9. The non-transitory computer-readable media of claim 8, further comprising inviting the one or more unconnected users to the suggested virtual space.

10. The non-transitory computer-readable media of claim 8, further comprising adding the one or more unconnected users as collaborators to a collaborative document within the suggested virtual space.

11. The non-transitory computer-readable media of claim 8, further comprising establishing a synchronous multimedia collaboration session corresponding to the user and the one or more unconnected users and the suggested virtual space.

12. The non-transitory computer-readable media of claim 8, further comprising launching the suggested virtual space within a user interface associated with a group-based communication system.

13. The non-transitory computer-readable media of claim 8, further comprising providing a suggested message from the user to the one or more unconnected users in the suggested virtual space.

14. The non-transitory computer-readable media of claim 8, further comprising saving the combined data set within a group-based communication system as a new internal data set.

15. A system for adding connections for a user, the system comprising:
a data store associated with a group-based communication system; and
at least one processor programmed to perform a method for adding connections for the user, the method comprising:
receiving, from a first external source of relationship data, a first external data set representing relationships among a first plurality of users;
receiving, from a second external source of relationship data, a second external data set representing relationships among a second plurality of users;
receiving an internal data set representing relationships among a plurality of internal users;
wherein the first plurality of users, the second plurality of users, and the plurality of internal users represent distinct overlapping sets of users;
generating a combined data set representing relationships between the first plurality of users, the second plurality of users, and the plurality of internal users; and
in response to determining that the combined data set contains one or more relationships not included in the internal data set between the user and one or more unconnected users:
presenting, to the user, a suggested virtual space including the user and the one or more unconnected users;
receiving, from the user, an action to engage with the suggested virtual space; and
in response to detecting the action, creating the suggested virtual space.

16. The system of claim 15, further comprising inviting the one or more unconnected users to the suggested virtual space.

17. The system of claim 15, further comprising adding the one or more unconnected users as collaborators to a collaborative document within the suggested virtual space.

18. The system of claim 15, further comprising establishing a synchronous multimedia collaboration session corresponding to the user and the one or more unconnected users and the suggested virtual space.

19. The system of claim 15, further comprising launching the suggested virtual space within a user interface associated with a group-based communication system.

20. The system of claim 15, further comprising providing a suggested message from the user to the one or more unconnected users in the suggested virtual space.
